(19) United States
(12) Patent Application Publication
(10) Pub. No.: US 2002/0072966 A1
(43) Pub. Date: Jun. 13, 2002

(54) System for providing targeted advertisements using advertiser-specific target groups

(76) Inventors: Charles A. Eldering, Doylestown, PA (US); Gregory C. Flickinger, Furlong, PA (US); John A. Schlack, Southampton, PA (US)

Correspondence Address: EXPANSE NETWORKS, INC., 300 NORTH BROADSTREET, DOYLESTOWN, PA, 18901, US

(21) Appl. No.: 09/731,606

(22) Filed: Dec. 7, 2000

Related U.S. Application Data
(60) Provisional application No. 60/229,156, filed on Aug. 31, 2000.

(51) Int. Cl. G06F 17/60

(52) U.S. Cl. 705/14

(57) ABSTRACT

In the present invention, advertisers can effectively perform targeted TV advertising using “advertiser-specific” target groups. Each advertiser defines its own target groups based on the preferred characteristics of the advertiser to form advertiser-specific target groups. Each person who is enabled to receive the advertisements (e.g., a subscriber to a cable TV service) is associated with appropriate target groups of the different advertisers, and this target group information may be stored at the subscriber's side or accessible by the subscriber's device such as a set top box or PVR. Based on the stored information, the advertisements that have been associated with the target groups of the subscriber, are then selected and displayed to the subscriber on a TV.

### RELATED APPLICATION

This patent application claims the benefit of priority based on U.S. Provisional Application No. 60/229,156 filed on Aug. 31, 2000, owned by the same assignee of the present invention, and entitled “Method and System for Addressable and Program Independent Advertising,” which is herein fully incorporated by reference.

### BACKGROUND OF THE INVENTION

1. Field of the Invention

The present invention relates to advertising and, more particularly, to a system and method for providing targeted advertisements using advertiser-specific target groups.

2. Discussion of the Related Art

Currently, a handful of marketing firms provide information about fixed groups known as “clusters” for use by advertisers in identifying the members of their target groups. “Clusters,” well known in the field of advertising, are groups of neighborhoods in the U.S. having certain similar characteristics such as socioeconomic, demographic, and/or psychographic characteristics. To form clusters, the marketing firms have examined the characteristics of all known neighborhoods in the country using Census Data or other publicly available data, have selected certain grouping characteristics (e.g., average family income, average family age, etc.), and have combined some of the neighborhoods with similar grouping characteristics into clusters. For example, in a simplified form, all neighborhoods in the country with an average family income of below $50,000 may be grouped as one cluster, whereas all neighborhoods with an average family income of $50,000 or higher may be grouped as another cluster. Examples of marketing firms known to provide “cluster” services are Claritas Inc. with its PRIZM Cluster system (identifiable by zip codes), CACI Inc. with its Acorn system, and National Decision Systems, Inc. with its Vision system.

Typically, in advertising, the advertiser contracts with one of the above described marketing firms for use of their “cluster” database. The advertiser examines the group characteristics of the clusters offered by the marketing firm, and selects one or more of the clusters that best represents the characteristics of likely buyers of the products that the advertiser is trying to advertise.

In determining which cluster to select, the advertiser may rely on questionnaires filled out by individuals, customer responses to the previous advertisements, product purchase and coupon usage by the customers, and/or other behaviour data. One example of such a system is disclosed in U.S. Pat. No. 4,908,761 to Tai, wherein a direct mailing list is generated using selected clusters. U.S. Pat. No. 4,908,761 is herein fully incorporated by reference.

Once the advertiser has selected the clusters, the neighborhoods belonging to the selected clusters are identified, e.g., by zip codes or other neighborhood identifiers. At this time, the advertiser may generate a direct mailing list of all individuals who reside in the identified neighborhoods and mail its advertising materials accordingly, or may contract with service providers (e.g., TV networks, cable TV companies, Internet service providers, etc.) to propagate its advertising materials to subscribers belonging to, or regions covering, the neighborhoods.

In targeted TV advertising, advertisements that have been selected or prepared to interest particular subscribers identified, for instance, using such cluster information, are inserted into TV programming streams for the identified subscribers by a TV service provider such that different viewers of the same television program view different advertisements that are particularly directed to them. PCT Patent Publication No. WO 99/66719 entitled “Techniques for Intelligent Video Ad Insertion” discloses at least one such scheme. Other such schemes are discussed in co-owned parent Provisional Patent Application No. 60/229,156.

Many advertisers seem to believe that the use of the clusters results in targeted advertising. However, a closer look reveals that the effectiveness of using the clusters is questionable because the clusters are not advertiser-specific or advertiser-defined. That is, the clusters were not formed with any particular advertiser in mind, but were formed by the marketing firms for use by all advertisers. This means the clusters may not necessarily identify the specific characteristics that are important to each advertiser. Further, different advertisers may prefer different grouping characteristics depending on the product being advertised and the advertising tactics. Thus, in reality, the use of these clusters does not necessarily result in effective targeted advertising.

An additional problem with traditional clustering is that the clusters have geographic limitations. An advertiser may want to address a group of individuals which are not located near each other and which form a very clear group or cluster but which are dispersed across a wide geographic area.

In view of the above and other problems with conventional methods of advertising, a need exists for an advertising method which provides greater flexibility to advertisers to define their target groups. A further need exists for an advertising method which improves the effectiveness of targeted advertising.

Accordingly, an object of the present invention is to provide a method and system for advertising using advertiser-specific target groups.

Another object of the present invention is to provide a method of providing targeted advertising using a group map.

A still another object of the present invention is to provide a method of providing targeted television advertising through television programming streams.

### SUMMARY OF THE INVENTION

In accordance with the present invention, advertisers can effectively perform targeted advertising (e.g., through televisions, the internet, radio, etc.) using “advertiser-specific” target groups. Each advertiser defines its own target groups based on the preferred characteristics of the advertiser to form “advertiser-specific” target groups. Each person who is enabled to receive the advertisements (e.g., a subscriber to a particular television programming provider, such as a cable television network) is associated with appropriate target groups of the different advertisers, and this target group information may be stored at the subscriber's side or accessible by the subscriber's device such as a set top box (STB). Based on the stored information, the advertisements that have been associated with the target groups of the subscriber, are then selected and displayed to the subscriber via a display unit (e.g., a TV monitor).

The present invention encompasses a system which presents an Advertiser User Interface (AUI) to an advertiser to support the generation of a query or queries relating to advertiser's desired target groups, the queries being used to generate a list of subscribers or geographic areas which fit the designated criteria or group characteristics identified by the advertiser in response to the queries. The system also includes a group manager which receives the results of the queries and forms advertiser specific target groups based on the received query results. The group manager may further match the subscribers or geographic areas to the advertiser specific target groups and may prepare a group map or a group list including such information. A group map or group list distributor can also be present and distribute the advertiser specific target groups to the appropriate ad insertion points.

### BRIEF DESCRIPTION OF THE DRAWINGS

FIG. 1 is a block diagram illustrating an environment in which the processing steps of the present invention may be applied;

FIG. 2 is a flowchart illustrating the processing steps involved in a method of advertising according to a preferred embodiment of the present invention;

FIG. 2A is a block diagram of an advertiser-specific target group forming system according to the present invention;

FIG. 3A is a pictorial representation of different advertiser-specific target groups which may be formed according to the present invention;

FIG. 3B is a chart illustrating an association of the advertisers with their target groups based on FIG. 3A;

FIG. 4A is one example of a group map which may be employed according to the present invention; and

FIG. 4B is another example of a group map which may be employed according to the present invention.

### DETAILED DESCRIPTION OF THE PREFERRED EMBODIMENTS

In this present specification, a “subscriber” includes a viewer, a household, a user, or any entity that has the capability of receiving the advertisements from advertisers according to the present invention. A “subscriber system” is a system at the subscriber's end which receives, processes, and/or displays media signals (e.g., video) including advertisement signals. A “head end system” is a system that originates the media signals and directs them to the subscriber systems.

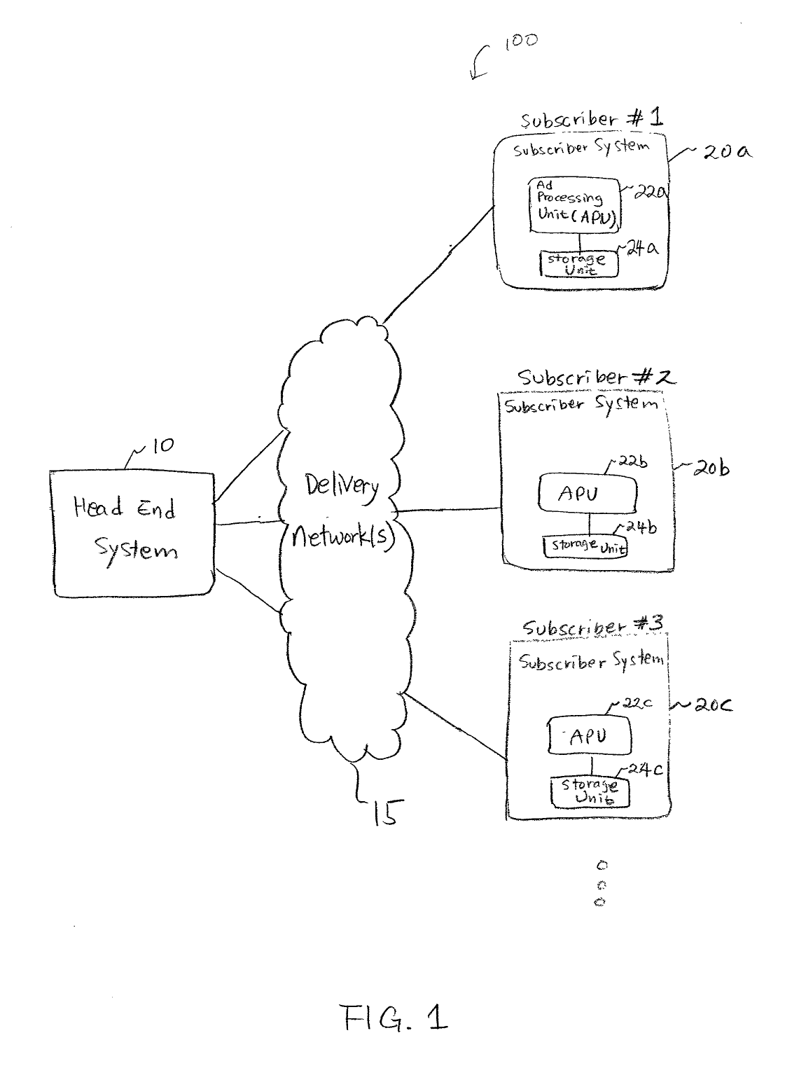

FIG. 1 is a block diagram illustrating one example of an environment in which the processing steps of the present invention may be applied. As shown in FIG. 1, a system 100 includes a head end system 10 and a plurality of subscriber systems 20a, 20b, 20c (collectively “20”), all operatively coupled through one or more delivery networks 15. The head end system 10 generates media signals (e.g., video signals including programming streams and advertisement signals) and transmits the media signals to the subscriber systems 20 through the delivery network 15. Examples of the head end system 10 may include, but are not limited to, service providers such as a television service provider (e.g., ABC network), a cable television service provider, an Internet service provider, a satellite service provider, a wireless television service provider, etc.

The media signals may be communicated between the head end system 10 and the subscriber systems 20 through one or more delivery networks 15. The media signals communicated between the head end system 10 and the subscriber systems 20 can be digital (e.g., MPEG) or analog, and may be communicated in any well known form (e.g., data streams) by antenna broadcast, analog cable, digital broadcast satellite (DBS), digital cable, switched digital video (SDV), local multipoint distribution system (LMDS), multichannel multipoint distribution system (MMDS), hybrid fiber coax (HFC), or any other means of communicating data.

For instance, the system shown in FIG. 1 may be any type of video or data delivery system. In one embodiment the architecture shown in FIG. 1 may represent a cable system. Although many cable systems are one-way, and do not have a return path, many systems have two-way capability, using a Data Over Cable System interface Spec (DOCSIS) compliant modem to provide return path communications. In the case where the delivery network 15 is a Hybrid Fiber Coaxial (HFC) cable network, a shared broadcast medium having a tree and branch architecture is utilized.

In another embodiment, the delivery network 15 may be a switched digital video (SDV) network in which a point-to-point connection is established between the head end system 10 and each subscriber system 20. In the SDV configuration, the point-to-point connections may be established using Very High Speed Digital Subscriber Lines (VDSL), coaxial cables, or a combination thereof. In the SDV configuration, a terminal is typically located in the field and is fed from the head-end via a fiber optic connection.

In another embodiment, the delivery network 15 may be a satellite based system such as a Direct Broadcast Satellite (DBS) wherein video signals are delivered directly to the subscriber systems 20. A return path may be present based on a phone line or other return path. Other terrestrial wireless networks such as MMDS or LMDS can be utilized to form the delivery network 15.

In another embodiment, the delivery network is the Internet and the delivery mechanism is streaming media. In streaming media, video and audio programming is delivered over the Internet or a private network through unicast or multicast connections. Advertisements can be inserted at the source or at the receiving point, which may be a set-top box, personal computer, or an Internet appliance. Because advertisements can be inserted into streaming media and multiple presentation streams can be created, advertiser specific groups can be formed.

The subscriber systems 20 receive the media signals from the head end system 10, and process and display them to the subscribers via a display unit, e.g., a monitor. Each of the subscriber systems 20 can include an advertisement processing unit 22a, 22b, or 22c, and a storage unit 24a, 24b, or 24c, all operatively connected. The advertisement processing units 22 are any means of processing advertisement signals, e.g., advertisement insertion units that are well known in the art, and the storage units 24 may be hard drives, RAM in set top boxes, optical disks, or other memory units well known in the art. Each of the subscriber systems 20 may further include components typically found in subscriber systems, such as a tuner, a demodulator, a modulator, a multiplexer, etc. Examples of the subscriber systems 20 may include, but are not limited to, an entertainment system (e.g., TV, VCR, Personal Video Recorder or PVR such as TiVo™ products, etc.) including or coupled to a set top box or the like, a personal computer, or a computer work station.

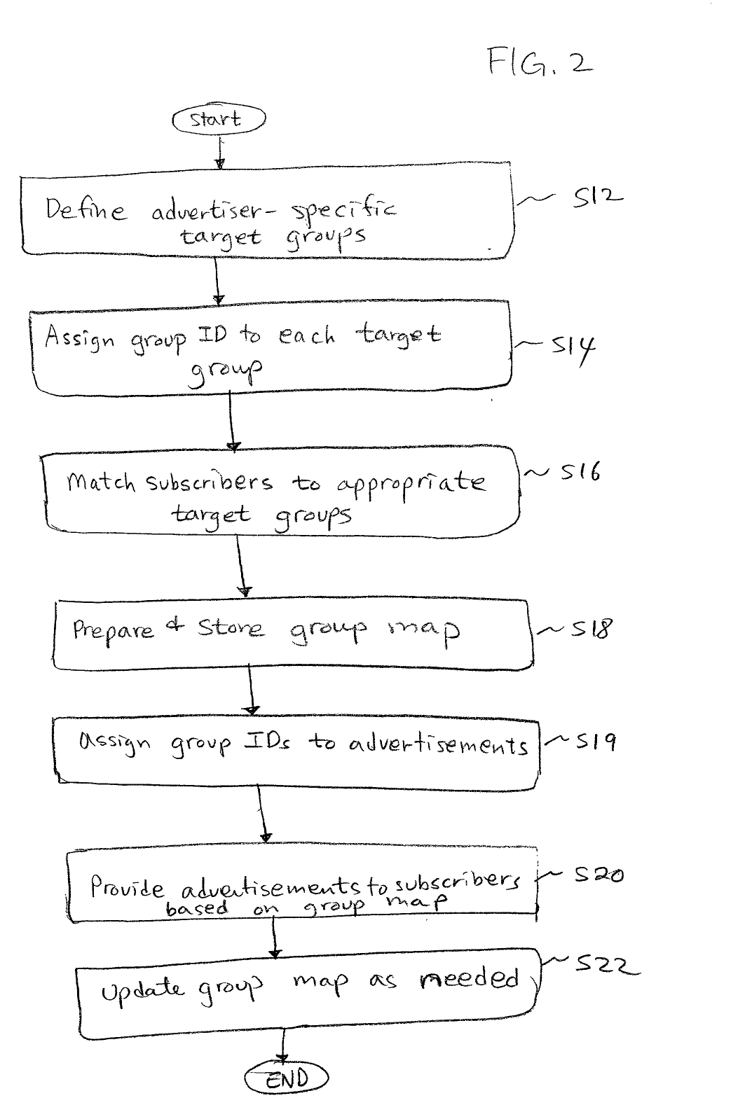

A preferred embodiment of the present invention is now described. FIG. 2 is a flowchart illustrating the processing steps of an advertisement method according to the preferred embodiment of the present invention.

Referring to FIG. 2, in Step S12, each of the advertisers is requested to define its own target groups based on its preferred grouping characteristics, i.e., “advertiser-specific” grouping characteristics. This can be accomplished by identifying grouping characteristics that the advertiser prefers and dividing the population into target groups based on the identified characteristics. Each advertiser can use a unique and different collection of grouping characteristics to define its own target groups, thereby creating “advertiser-specific” target groups. For example, one advertiser may define its target groups based on income level whereas another advertiser may define its target groups based on education level. Any one or a combination of boolean expressions (e.g., OR, AND) can be used to connect the grouping characteristics to define the target groups. The advertisers may also rely on consumer survey data or other behavioral data in identifying the grouping characteristics which best reflect the characteristics of the likely buyers of the advertising products. In another embodiment, the advertisers may select grouping characteristics based on the viewing habits of the subscribers, e.g., based on which advertisements were viewed (partially or entirely) by the subscribers. The information on the viewing habits of the subscribers (e.g., the types of programs the subscriber tends to view) may be obtained, for instance, from surveys, questionnaires, or Nielsen type data collection. Alternately, technology is now available by which set top boxes coupled to a communication network can report both to the head end of the network what programs have been viewed using that set top box. One such system and method is disclosed in U.S. patent application Ser. No. 09/452,893 filed on Dec. 2, 1999, entitled “Subscriber Identification System” and owned by the same assignee of the present invention, which is herein fully incorporated by reference.

Grouping does not always involve geographic constraints or limitations, and although it is possible to impose geographic constraints on the members of a group, it is often the case that the members of the group are widely dispersed across an area such as a cable television franchise or satellite broadcast area.

Geographically dispersed grouping can occur when the television delivery mechanism has no geographic constraints, such as is the case when Personal Video Recorders (PVRs) are used in conjunction with the video delivery. As an example, PVRs may be utilized in conjunction with a direct satellite broadcast system in which case the groups may be formed across the entire satellite footprint, which may extend across the entire country or the entire service receiving territory.

In Step S14, a unique group identifier (ID) is assigned to each of the target groups defined by the different advertisers. The group ID may be a number, a letter, a word, or any combination thereof, and preferably identifies the specific target group of the advertiser and the advertiser itself. In one embodiment, the group IDs may be based on or incorporate advertiser IDs typically used to identify the advertisers for scheduling and billing purposes. For example, if the advertiser ID of the advertiser is “001,” then the target groups for this advertiser may be identified using group IDs such as “001A, 001B, 001C, and 001D.” These group IDs uniquely identify the advertiser and its target groups.

In Step S16, appropriate group IDs of the different advertiser are assigned to each subscriber. To assign the group IDs, a determination may be made whether or not each subscriber belongs to any of the target groups of different advertisers using U.S. Census data or other available data (e.g., demographic data from Claritas Inc.) which may identify certain characteristics (e.g., age, sex, occupation, viewing habits, favourite shops, etc.) of each subscriber. If the determination indicates that the subscriber has the characteristics of certain target groups, then the group IDs corresponding to those target groups are assigned to the subscriber. In one embodiment, the advertiser may define its targets groups (e.g., by defining group characteristics using boolean expressions—AND, OR, AND/OR, etc.) so that each subscriber may belong to only one target group of that advertiser. In another embodiment, the advertiser may define its target groups such that each subscriber may belong to multiple target groups of a particular advertiser. In a different embodiment, if the subscriber has characteristics that are identified in two or more of the target groups defined by the advertiser, then one of these target groups may be selected based on certain criteria (e.g., the order of importance of the characteristics). In all embodiments, in general, multiple group IDs from different advertisers are assigned to each subscriber.

In Step S18, once the group IDs have been assigned to each subscriber, a group map is prepared, e.g., by the head end system 10. The group map identifies a list of subscribers and the group IDs assigned to each of the listed subscribers. To accomplish this, the subscribers are identified by subscriber IDs which may be a number, a word, a symbol, or any combination thereof. In one embodiment, the subscriber ID is a set top box number (e.g., MAC id) identifying the set top box of the subscriber. The group IDs assigned to the subscribers are associated with the corresponding subscriber IDs of the subscribers.

Once the group map is prepared, it is stored in each of the subscriber systems 20, the head end system 10, or other systems coupled to the subscriber or head end systems. At each of the subscriber systems 20, the group map can be stored in the storage unit 24, whereas at the head end system 10, the group map may be stored in a database, RAM, ROM, or any other memory unit residing in or coupled to the head end system 10. Instead of storing the entire group map in each of the subscriber systems 20, it is also possible for each of the subscriber systems 20 to store only a portion of the group map which is relevant to the particular subscriber system (i.e., only the group IDs pertaining to that subscriber and not the group IDs pertaining to other subscribers).

In the event that the group map is stored remote from the point of insertion of the advertisement, it is possible to access the group over a network, such as the Internet. This can be the case when the group map is stored on a server and the actual insertion is performed in a set-top box. Another example is when the group map is stored on a server in one location, and the insertions is performed at another centralized location such as a cable head-end.

In Step S19, a determination is made as to which advertisement should be shown to which target group according to the advertiser's instructions or predetermined rules. For example, the advertiser may have different versions of the advertisement to be shown to its different target groups or may want to advertise different products to the different target groups. A target group ID is assigned to each of the available advertisements. This process may be computer-implemented in the head end system 10. A library of advertisements with the assigned group IDs may be stored in the head end system 10, the subscriber system 20 or a remote system coupled to the head end system or subscriber system.

In Step S20, once the group map is formed and the group IDs have been assigned to the advertisements, targeted advertising is provided to the subscribers using the group map. This can be accomplished in a number of different ways and may vary depending on the field and nature of application.

For example, in accordance with one embodiment, if the group map is stored in the subscriber system 20 of a particular subscriber, the subscriber system 20 identifies the group IDs that have been assigned to the particular subscriber by examining the stored group map, and selects the advertisements (e.g., from the library of advertisements or an ad channel) having a group ID that matches one of the group IDs assigned to the particular subscriber. The subscriber system 20 can store the selected advertisements in any memory associated therewith for subsequent showing or can display them in real time via a monitor or screen. For example, in broadcast TV or cable TV service systems, the subscriber system 20 of a particular subscriber may receive programming streams containing TV/video programs and openings (or “avails”) for inserting advertisements therein, which is disclosed in detail in the above-identified Provisional Application No. 60/229,156. In such systems, the subscriber system 20 can select the advertisements based on the group map as discussed above and insert the selected advertisements into the avails of the incoming programming streams in real time for display to the subscriber. In another example, the selection of the advertisements based on the group can be made in advance by the subscriber system 20 and the selection results can be prestored in a memory associated with the subscriber system, such that the subscriber system 20 merely retrieves the stored selected advertisements and inserts them into the incoming programming streams for displaying to the subscriber. In still another example, one or more channels of advertisements can be transmitted to the subscriber system 20 from the head end system 10 or the like, wherein the subscriber system 20 selects certain advertisements from the advertisements in the designated advertisement channel based on the group map for subsequent showing or immediate insertion into the incoming programming streams.

The group map may be used in conjunction with a variety of mechanisms, which provide for advertisement substitution. One of these mechanisms is the forced channel tuning technique in which, at the time of an advertisement, the subscriber's television is tuned to a particular feeder channel to receive a targeted advertisement This feeder channel may be contained within a particular statistical multiplexer or may be on a separate channel (frequency).

Another mechanism is local substitution of an advertisement from memory in a set-top box, personal computer, or Internet appliance. Substitution may be made on an MPEG or other video stream, or an audio stream played from local memory or received over a broadcast or streaming media connection.

In accordance with another embodiment, if the group map is stored only in the head end system 10, then the head end system 10 may select, for each subscriber, the advertisements with the group IDs that match the group IDs assigned to the subscriber, and transmit the selected advertisements to the different subscriber systems 20. That is, the head end system 10 may send different advertisements to the different subscriber systems 20 depending on the group IDs assigned to each subscriber.

The order and manner in which these advertisements are displayed to the subscribers may be based on predetermined rules or ordering algorithms well known in the art.

In Step S22, the group map stored in the subscriber systems 20 or head end system 10 can be updated periodically or whenever updating is needed (e.g., when the advertisers have changed their target groups) . If the group map is stored in the subscriber systems 20, then the head end system 10 may transmit a new group map to the subscriber systems 20. The subscriber systems 20 receive the new group map, discard the old group map, and store the new group map in the system. In the alternative, a new group map can be stored on a portable storage unit such as a disk, CD, etc., the portable storage unit can be mailed to the subscribers who then download the information into their subscriber systems. In a different embodiment, if changes to the target groups are known in advance, then these changes may be included in the current group map so that the group changes can be implemented without having to replace the current group map. For example, the current group map may include a list of the current target groups as well as the new (next) target groups and the time at which the next target groups become effective. The next group starting time can be represented in a variety of different ways, e.g., in the familiar “hh:mm:ss” format or by the number of seconds from some fixed time frame. The subscriber systems 20 can be pre-configured to look for the next group starting time in the group map, and to begin using the new target group when the designated time arrives. This process can reduce the frequency in which the group map needs to be replaced or updated.

One skilled in the art would readily understand that some of the processing steps discussed above may be performed in a different order than what is illustrated in FIG. 2 without effecting the operation. For example, Step S19 may be performed immediately after Step S14, or Step S22 may be performed at any time after Step S18.

FIG. 2A shows a functional block diagram of an advertiser-specific target group forming system 30 in accordance with the invention. The system 30 may be utilized to implement some or all of the processing steps shown in FIG. 2. In one embodiment, the system 30 may be installed at the head end system 10 or in the system 100 shown in FIG. 1. In another embodiment, the system 30 may be spread out throughout the entire system 100 shown in FIG. 1.

As shown in FIG. 2A, the system 30 includes an Advertiser User Interface (AUI) 31, a query generator 32, a group manager 33, one or more databases 34, and a group map distributor 35, all operatively coupled. The AUI 31 presents a query or queries relating to advertiser's desired target groups to an advertiser. These queries are generated by the query generator 32 to elicit responses (e.g., advertiser group parameters) from the advertiser. The group manager 33 receives the results of the queries and forms advertiser-specific target groups based on the received query results. The group manager 33 may further match the subscribers or geographic areas to the advertiser-specific target groups and prepare a group map or group list including such information. To accomplish this, the group manager 33 may access the databases 34 which may store information on all subscribers or groups of subscribers on the network, and other subscriber characteristic data. The group map distributor 35 distributes the group maps to the appropriate ad insertion points (e.g., to the head end, the subscriber's device such as STB or PVR, or a server remote to the subscriber's device, etc.) to transmit the advertiser-specific target grouping information to the ad insertion points. The received group maps may be processed and used to deliver targeted advertisements to individual subscriber households or groups of subscriber households as discussed herein above.

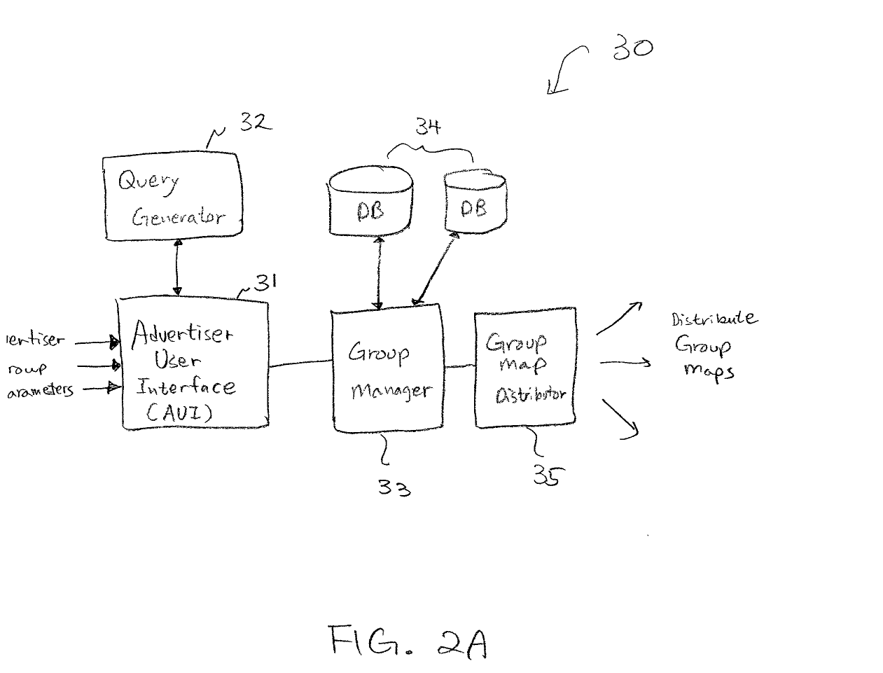

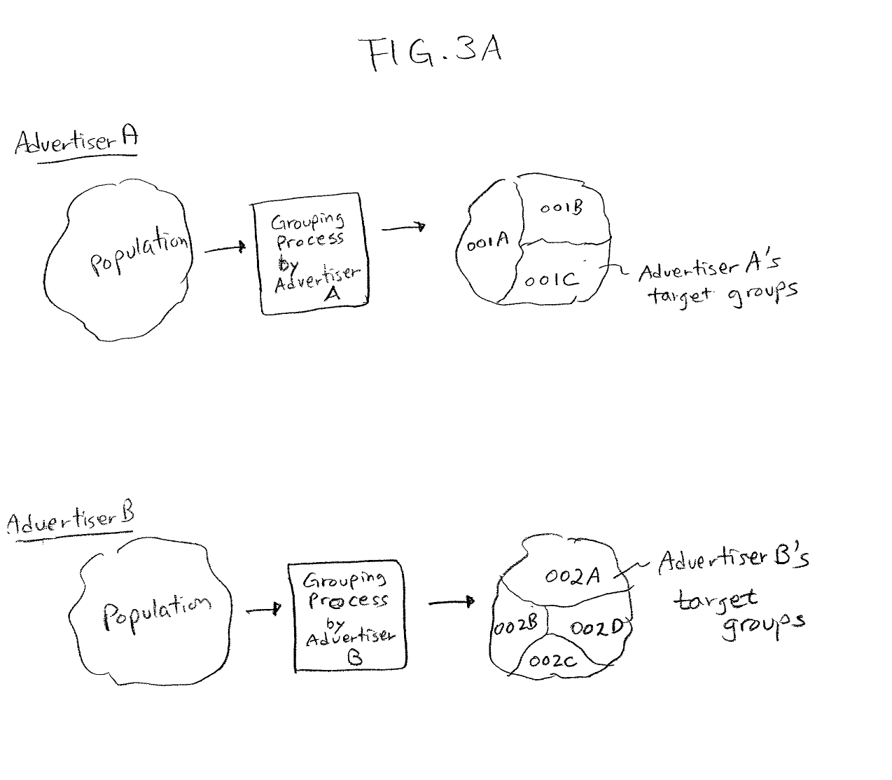

FIG. 3A is a pictorial representation of examples of different target groups which may be formed by different advertisers (e.g., Advertisers A and B) according to the present invention, and FIG. 3B is a chart based on FIG. 3A provided for enhancing the understanding of the invention. As shown in FIG. 3A, Advertiser A may select certain group characteristics to divide the population into target groups “001A, 001B and 001C” that are unique to Advertiser A. On the other hand, Advertiser B may select completely different group characteristics and form target groups “002A, 002B, 002C and 002D” which are unique to Advertiser B. The chart in FIG. 3B identifies the advertiser IDs, and the group IDs and group characteristics associated with the advertiser IDs. For example, it indicates that Advertiser A (with advertiser ID “001”) has formed three target groups (with group IDs “001A, 001B, and 001C”) using group characteristics such as “affluent singles”, “middle class families” and “seniors.” On the other hand, Advertiser B (with advertiser ID “002”) has used different group characteristics such as “watch Monday Night Football,” “watch Oprah,” “watch Survivor AND drive BMW,” and “watch 60 Minutes OR Dateline” to form its own target groups “002A, 002B, 002C and 002D.”

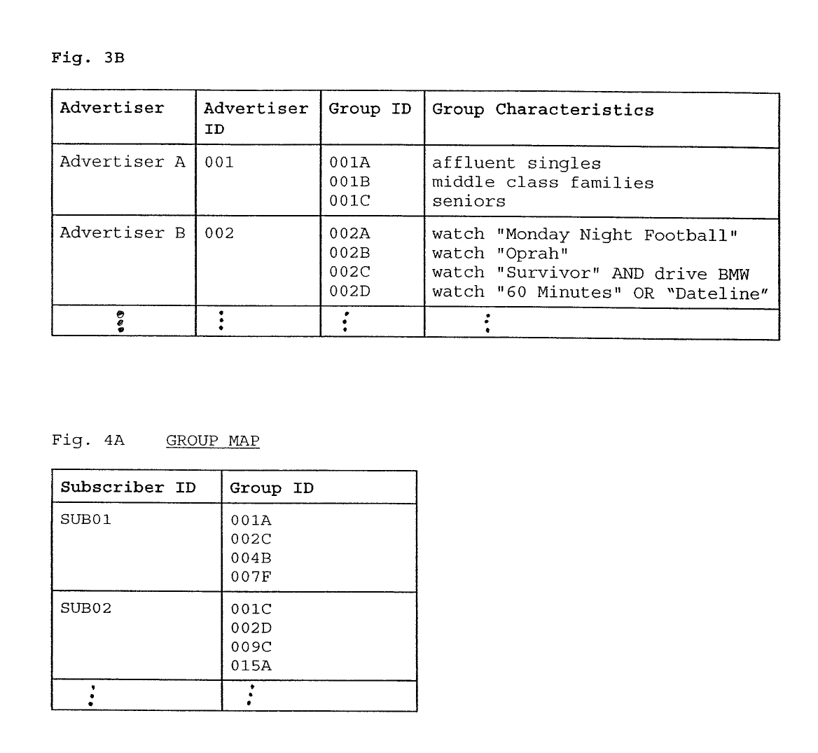

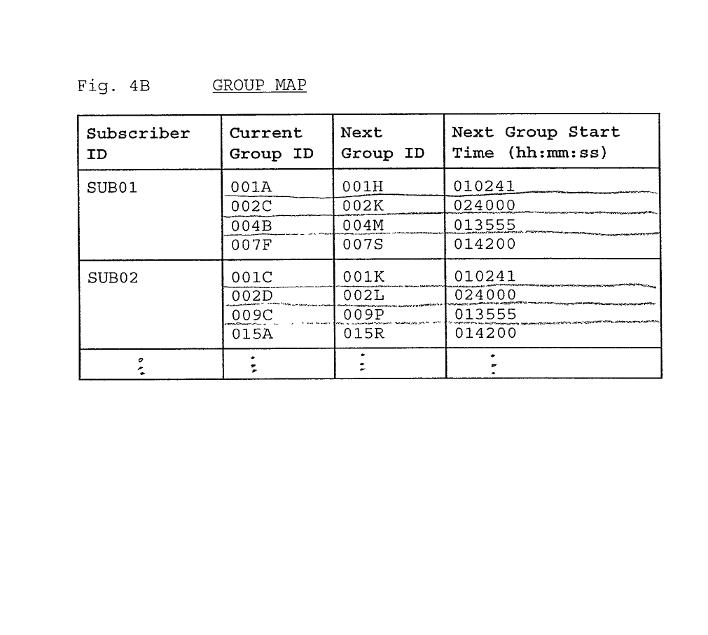

FIG. 4A is an example of a group map which may be stored in the subscriber systems 20 and/or header system 10 according to the present invention. As shown in FIG. 4A, the group map may identify a series of subscriber IDs (e.g., SUB01, SUB02 . . . ), and a list of target group IDs associated with each of the subscriber IDs. As noted above, the group map indicates target groups to which each subscriber belongs. In this example, the group map indicates that the subscriber (with subscriber ID “SUB01”) belongs to the following target groups: group “001A” of advertiser 001, group “002C” of advertiser 002, group “004B” of advertiser 004, and group “007F” of advertiser 007.

FIG. 4B is another example of a group map which may be stored in the subscriber systems 20 and/or head end system 10 according to the present invention. The group map shown in FIG. 4B is identical to that shown in FIG. 4A, except for the addition of next target groups and next group starting time discussed above in connection with Step S22. As shown in FIG. 4B, in this example, the current subscriber “SUB01” belongs to target groups “001A, 002C, 004B and 007F” whereas in the future, starting at 1:02 pm, 41 seconds, the subscriber will belong to target groups “001H, 002K, 004M and 007S.”

The processing steps of the present invention can be implemented in any system which allows the insertion of advertisements into available spots in programming streams, such as the system disclosed in U.S. Pat. No. 5,724,091 to Freeman et al., U.S. Pat. No. 5,715,018 to Fascia, U.S. Pat. No. 5,600,366 to Schulman, U.S. Pat. No. 4,602,279 to Freeman, PCT Patent Publication No. WO 00/16544 to Freeman et al., or PCT Patent Publication No. WO 00/2187 to Klosterman, each of these references being herein fully incorporated by reference. In such systems, the group map identifying the advertiser-specific target groups to which each subscriber belongs, can be used to determine which advertisement to store in the system and/or which advertisement to select and insert into the programming stream for displaying to the subscriber.

In another embodiment, the processing steps of the present invention may be applied in a queue-based advertisement insertion system, which is the subject matter of the related co-pending application, U.S. Ser. No. ______, filed on Nov. 14, 2000, entitled “Queue Based Advertisement Scheduling And Sales” (Docket No. T721-10), owned by the same assignee of the present invention, which is herein fully incorporated by reference. In the system disclosed in the related application, one or multiple queues may be provided in a set top box on the subscriber's side. The queue identifies the order in which certain advertisements may be inserted into the programming stream and viewed by the subscriber, and locations (i.e., ARLs) where these advertisements are stored. In applying the present invention, advertisements may be identified with advertiser-specific target group IDs and a group map may be accessible by the set top box. The set top box determines the group IDs assigned to the subscriber based on the group map, and selects only the advertisements with the same group IDs. Once the advertisements have been selected, the set top box may arrange the order in which the selected advertisements are to be played and store the ordering information of the selected advertisements in the queue. At the proper time, the selected advertisements are displayed to the subscriber according to the order set by the queue. As a result, targeted advertising can also be provided in a queue-based advertisement system.

In still another embodiment, the processing steps may be applied in a system such as an SDV system, which is disclosed in the above-identified Provisional Application No. 60/229,156. In such a system, the head end system is able to direct different advertisements to one or more of its subscribers' set top boxes on different advertisement channels. Thus, in applying the present invention, the head end system may assign one or more advertisement channels to each subscriber and the group map may further include a list of advertisement channels or channel identifiers (e.g., VPI/VCIs) associated with the subscribers. Each advertisement channel can carry targeted advertisements directed to only one subscriber or a group of subscribers, wherein such targeted advertisements are selected by the head end system based on the target groups identified in the group map as discussed above. The head end system may transmit the advertisements to each subscriber system through the advertisements channels. Each subscriber system can tune to the particular advertisement channel identified in the group map for the corresponding subscriber, and can store all the advertisements on the selected advertisement channel or can store only those advertisements which have been tagged with the group IDS of the corresponding subscriber as identified in the group map. The stored advertisements are used for subsequent showing as discussed above.

In accordance with the present invention, the system can be realized using a server of networked databases and appropriate advertiser interfaces such as the AUI 31 and the query generator 32. In one embodiment, the databases are realized using a commercially available database system such as the one sold by Oracle. Interfaces may be developed in a number of ways, but in a preferred embodiment, they are web based and are realized in Java or JavaScript. The advertiser may select the appropriate groups or group characteristics using the interfaces, which prepare the corresponding query or queries to be used to form advertiser-specific target groups.

Once the groups are formed, the group maps can be stored at the point where they were created, transmitted to another centralized location, or sent to the subscribers units (set top boxes or PVRs) for storage and local ad insertion. These maps may be transmitted across the Internet or across another data network or television distribution system.

In the present invention, advertisers are not limited to the standard grouping characteristics that are typically used by the marketing firms in forming the clusters, but are free to choose any characteristics that the advertiser is interested in to define its own target groups. Therefore, the present invention offers greater flexibility to the advertisers in forming their “advertiser-specific” target groups that best represent the characteristics of the likely buyers of the advertising products. Furthermore, the present invention provides improved targeted advertising because only those advertisements that belong to the advertiser-specific target groups of the subscriber may be displayed to the subscriber.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A system for creating advertiser-specific target groups, the system comprising:
a query generator for forming at least one query;
an advertiser interface for directing the at least one query to an advertiser and receiving a response to the at least one query from the advertiser, the response including advertiser-specific group parameters; and
a group manager for receiving the advertiser's query response and forming advertiser-specific target groups based on the query response.

2. The system of claim 1, wherein the group manager associates the advertiser-specific target groups with subscribers or subscriber groups on a network using subscriber information, and prepares a group map according to the association.

3. The system of claim 2, wherein the network is a television service network.

4. The system of claim 2, further comprising:
a database, accessible by the group manager, for storing the subscriber information.

5. The system of claim 3, further comprising:
a group map distributor for distributing the group map to an advertisement insertion device used to delivery targeted advertisements to the subscribers.

6. The system of claim 5, wherein the group map distributor distributes the group map through a distribution network.

7. The system of claim 6, wherein the distribution network is the Internet.

8. The system of claim 5, further comprising:
a storage unit, accessible by the group map distributor, for storing therein the group map.

9. The system of claim 8, wherein the storage unit is located at a head end of the network.

10. The system of claim 8, wherein the storage unit located at a subscriber's side.

11. The system of claim 8, wherein the storage unit is located at a subscriber's set top box.

12. The system of claim 8, wherein the storage unit is located on a server accessible by a subscriber's device through a communications network.

13. The system of claim 12, wherein the communications network is the Internet.

14. The system of claim 2, wherein the group map identifies a list of subscribers and a list of advertiser-specific target groups associated with each of the listed subscribers.

15. The system of claim 14, wherein the group map further identifies a list of advertisement channels associated with the listed subscribers, the advertisement channels used for delivering television programming streams.

16. A subscriber system for a particular subscriber, comprising:
means for storing a group map, the group map identifying a list of subscribers and a list of advertiser-specific target groups associated with each of the listed subscribers, the list of subscribers including the particular subscriber; and
means for advertising to the particular subscriber based on the stored group map.

17. The system of claim 16, further comprising:
means for storing a library of advertisements each associated with at least one of the listed target groups.

18. The system of claim 17, wherein the means for advertising includes:
means for selecting, from the stored library of advertisements, advertisements that are associated with the target groups that are associated with the particular subscriber, using the stored group map; and
means for displaying the selected advertisements to the particular subscriber.

19. The system of claim 18, wherein the means for advertising receives at least one media stream from a communications network, inserts the selected advertisements into the received at least one media stream, and displays the at least one media stream with the inserted advertisements to the particular subscriber using the means for displaying.

20. The system of claim 19, wherein the communications network is a television service network.

21. The system of claims 19, wherein the communications network is an Internet service network.

22. The system of claim 19, wherein the means for advertising receives the at least one media stream through one of following delivery networks: analog cable network, digital broadcast satellite (DBS) network, digital cable network, switched digital video (SDV) network, hybrid fiber coaxial (HFC) cable network, Internet, or wireless television service network.

23. The system of claim 19, wherein the at least one media stream is a television program stream.

24. The system of claim 18, wherein the group map further identifies a list of advertisement channels associated with the listed subscribers, and the means for advertising advertises using the listed advertisement channels of the group map.

25. The system of claim 16, wherein the means for storing the group map is located at a head end.

26. The system of claim 25, wherein the means for advertising is located at a set top box.

27. The system of claim 16, wherein the means for storing the group map is located on a server accessible by a subscriber's device.

28. A method of providing subscriber-specific advertisements using advertiser-specific target groups, comprising the steps of:
forming a set of advertiser-specific target groups for each of a plurality of advertisers based on advertiser-specific group characteristics;
associating the target groups from each of the sets with at least one subscriber based on certain characteristics of the at least one subscriber;
storing results of the associating step in an advertisement processing system; and
providing subscriber-specific advertisements to the at least one subscriber based on the stored results.

29. The method of claim 28, wherein the associating step includes:
assigning a unique group identifier (ID) to each of the target groups, each group ID identifying the target group and the advertiser; and
assigning a subscriber ID to the at least one subscriber for identifying the subscriber.

30. The method of claim 29, wherein the associating step further includes:
identifying the target groups to which the at least one subscriber belongs based on the characteristics of the at least one subscriber; and
associating the group IDs of the identified target groups with the subscriber ID of the at least one subscriber; and
preparing a group map based on results of the group ID associating step.

31. The method of claim 30, wherein, in the preparing step, the group map identifies the at least one subscriber ID and the group IDs assigned to the at least one subscriber ID, and the storing step stores the group map in the advertisement processing system.

32. The method of claim 31, further comprising the step of:
updating the stored group map based on new advertiser-specific target groups from the advertisers.

33. The method of claim 30, wherein the providing step includes:
associating each of a plurality of advertisements with an appropriate group ID for identifying the target group to which the advertisement belongs;
selecting the advertisements associated with the group IDs which match the group IDs associated with the subscriber ID of the at least one subscriber ID; and
displaying the selected advertisements to the at least one subscriber.

34. The method of claim 28, wherein the storing step stores the results of the associating step in a set top box of the advertisement processing system.

35. The method of claim 28, wherein the storing step stores the results of the associating step at a head end of the advertisement processing system.

36. The method of claim 28, wherein the storing step stores the results of the associating step on a server in the advertisement processing system.

37. A method of providing subscriber-specific advertisements, comprising the steps of:
identifying a list of subscribers and a list of advertiser-specific target groups associated with each of the listed subscribers;
storing results of the identifying step locally to each of the listed subscribers; and
selecting, by an advertisement processing system of each of the listed subscribers, advertisements based on the stored results of the identifying step, so as to provide the subscriber-specific advertisements to each of the listed subscribers.

38. The method of claim 37, wherein, in the storing step, the results of the identifying step are stored as a group map, wherein, in the group map, the list of subscribers are identified with unique subscriber IDs (identifiers), and the list of advertiser-specific target groups are identified with unique group IDs.

39. The method of claim 38, wherein the selecting step includes:
providing a plurality of advertisements each assigned with a group ID for identifying the target group to which the advertisement belongs;
selecting, from the provided advertisements, advertisements with the group IDs associated with each of the listed subscribers, wherein the advertisements selected for one subscriber differ from the advertisements selected for another subscriber.

40. A method of advertising to subscribers, comprising the steps of:
storing a group map in an advertisement processing system, the group map identifying a list of subscribers and a list of advertiser-specific target groups associated with each of the listed subscribers; and
advertising to the listed subscribers based on the stored group map.

41. The method of claim 40, further comprising the step of:
storing a library of advertisements each associated with at least one of the target groups.

42. The method of claim 41, wherein the advertising step includes:
selecting, from the stored library of advertisements and for each of the listed subscribers, advertisements that are associated with the target groups which are associated with the subscriber, using the stored group map; and
displaying the selected advertisements to the listed subscribers.

43. The method of claim 42, wherein the displaying step includes:
receiving, by the advertisement processing system of each of the listed subscribers, at least one media stream from a communications network;
inserting the selected advertisements for each of the listed subscribers into the received at least one media stream; and
displaying, to each of the listed subscribers, the at least one media stream with the inserted advertisements.

44. The method of claim 43, wherein, in the receiving step, the communications network is a television service network.

45. The method of claims 43, wherein, in the receiving step, the communications network is an Internet service network.

46. The method of claim 43, wherein, in the receiving step, the at least one media stream is received through one of following delivery networks: analog cable network, digital broadcast satellite (DBS) network, digital cable network, switched digital video (SDV) network, hybrid fiber coaxial (HFC) cable network, Internet, or wireless television service network.

47. The method of claim 43, wherein, in the inserting step, the at least one media stream is a television program stream.

48. The method of claim 42, wherein, in the selecting step, the advertisements selected for one subscriber differ from the advertisements selected for another subscriber.

49. The method of claim 40, wherein, in the storing step, the group map further identifies a list of advertisement channels associated with the listed subscribers, and wherein the advertising step advertises using the listed advertisement channels of the group map.

50. The method of claim 40, wherein, in the storing step, the group map is stored at each set top box in the advertisement processing system.

51. The method of claim 40, wherein, in the storing step, the group map is stored at a head end of the advertisement processing system.

52. The method of claim 40, wherein, in the storing step, the group map is stored on a server in the advertisement processing system.

53. A method of advertising to subscribers, comprising the steps of:
storing a group map in an advertisement processing system of each of subscribers, the group map identifying a list of the subscribers, a list of current advertiser-specific target groups associated with each of the listed subscribers, and information on next advertiser-specific target groups associated with each of the listed subscribers; and
advertising to the listed subscribers based on the stored group map.

54. The method of claim 53, wherein, in the storing step, the information includes a list of new advertiser-specific target groups associated with each of the listed subscribers, and time information identifying when the new target groups become effective, and wherein the method further comprises the step of:
replacing the current target groups with the list of new target groups based on the time information.

55. The method of claim 53, further comprising the step of:
storing a library of advertisements each associated with at least one of the current and new target groups.

56. The method of claim 55, wherein the advertising step includes:
selecting, from the stored library of advertisements and for each of the listed subscribers, advertisements that are associated with the current target groups which are associated with the subscriber, using the stored group map; and
displaying the selected advertisements to the listed subscribers.
